(19) United States
(12) Patent Application Publication
(10) Pub. No.: US 2024/0152935 A1
(43) Pub. Date: May 9, 2024

(54) System for Securing and Authenticating Art Property Rights

(71) Applicant: Kathryn Lloyd, St. George, UT (US)

(72) Inventor: Kathryn Lloyd, St. George, UT (US)

(21) Appl. No.: 17/982,982

(22) Filed: Nov. 8, 2022

(51) Int. Cl. G06Q 30/00

(52) U.S. Cl. CPC G06Q 30/0185; G06Q 2220/00

(57) ABSTRACT

A computer driven system is proposed to allow for embedding of unique identification devices in canvas, creating artwork on the canvas, scanning the original artwork, and then sending the scanned images to a master controller for purposes of registering the artwork. Rather than sending scanned images to a master controller remotely, a public website can be established to receive the scanned images.

### FIELD OF THE INVENTION

The present invention relates to a virtual system for securing and authenticating the property rights of artists.

### BACKGROUND OF THE INVENTION

Artists should have the ability to inexpensively protect their work from fraudulent reproductions. Art work that has been reduced to canvas or other substrate material is vulnerable to unwanted copying. The great art masters have had their works knocked-off. It has sometimes been said tongue-in-cheek, that of the 750 paintings and etchings created by Rembrandt, only 3,000 are still available.

A possible solution to restrict or eliminate unwanted copying, which is minimally expensive, easy to use, and provides irrefragable authentication of original art, is virtual art registration. By registration using internet resources, an artist can feel confident in creating art which have remunerative value to him or her alone.

### SUMMARY OF THE INVENTION

The invention involves a Quick Response (“QR”) Code embedded in the canvas or other substrate material on which the artist will create his or her work of art. QR Code is commonly described as an two-dimensional, two-color barcode which is unique for each application. Each QR Code stores information as a series of pixels in a square-shaped grid that can be read by a digital device, such as a smart phone.

An alternative is to use the QR Code to improve accessibility of a Non-Fungible Token (“NFT”). This alternative permits greater storage capacity, where the canvas can be embedded with the NFT containing a QR Code. NFT is a cryptographic asset in a blockchain with unique identification codes and metadata to distinguish one NFT from another. A blockchain is a distributed database, which acts like a ledger, that is shared among the internet users on the network. As a database, a blockchain stores information electronically in digital format. The NFT is in current use serving as a medium for commercial transactions.

The elements of the system involve an artist creating an original art work on canvas embedded with QR Code or NFT. On completion the artist uses his or her smart phone to scan the original art work and send the scanned data to a computer terminal belonging to a master controller. The master controller will create a ledger or registry of the art work for later use in verifying date/time of creation.

Should an issue arise later as to authenticity of a piece of art, the canvas can be scanned for the presence of the QR Code or NFT. Each QR Code or NFT will be unique to the canvas on which the artist will create the original art work.

In another embodiment, instead of engaging in traditional sales of art works, the artist can license the work to potential buyers. Since the ledger system involving the embedded NFT always tracks the location of the art, the artist can also track sales or transfers of the art, and as applicable, continue to receive a share of each future transfer of his or her art. The potential buyers will have access to market information through the ledger system, and will be able to recover licensing fees paid through transfers to future licensees.

### BRIEF DESCRIPTION OF DRAWINGS

FIG. 1 contains a flow chart graphically depicting the elements of one embodiment of the system. Step one involves embedding the canvas with QR Code, which includes sealing the barcode, and purchase by the artist. Step two involves creating the original artwork. Step three involves the artist scanning his or her artwork with a smart phone or other portable device. Step four involves sending the scanned image to the computer terminal belonging to a master controller for purposes of developing a registry of original artwork, cataloged by date and time of receipt of the scanned image. And step five is optional, where the artist can contract or license the digital image which represents the original art.

### DETAILED DESCRIPTION OF EMBODIMENTS

The problem being addressed is inexpensive authentication and protection of artwork. The technology to provide authentication is available in the form of machine readable barcodes, called QR Codes, and in NFT, which have increased storage capability. The NFT is used as a key building block in many diverse and non-centralized, crypto-currency systems. The NFT can be adapted to accommodate storage of data from scanned images of art.

In one embodiment of the system, the system is computer driven comprising a tangible, non-transitory, machine readable medium storing instruction that when executed, sends data related to an original artwork painted on a canvas containing an embedded quick response code, from at least one artist with a smart phone capable of scanning and sending a photographic representation of the original artwork, to a master controller with at least one computer with a terminal, monitor screen and enabling software to receive the data related to the original artwork. The master controller will then create a registry of all artwork received from at least one artist. The foregoing steps can be repeated by other artists without numerical limitation, since registration is virtual.

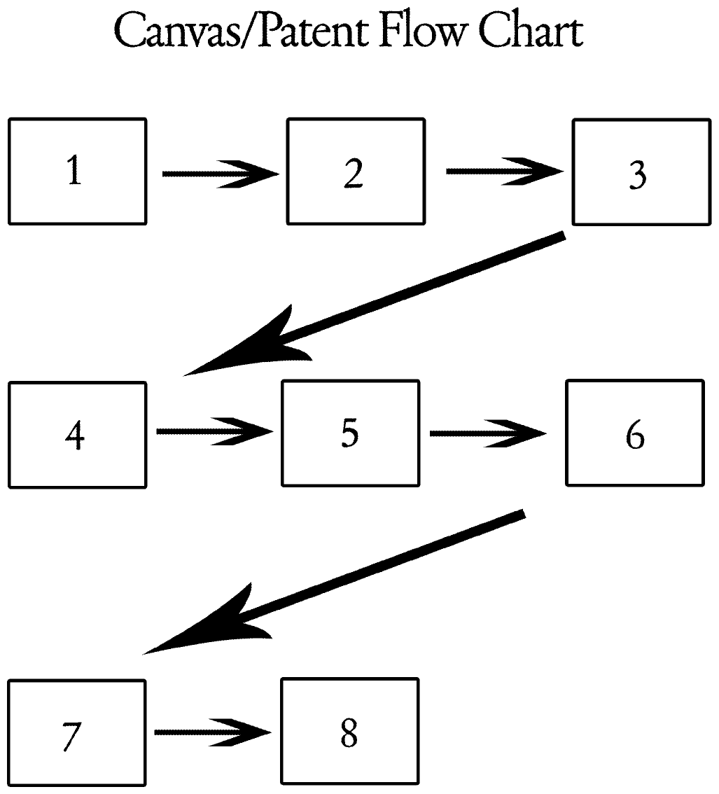

In one embodiment, the elements of the system comprise a series of steps identified at FIG. 1. Box 1 shows step one which involves embedding the canvas with QR Code. The QR Code is device which is typically square in shape, containing unique data that can later be electronically or wirelessly transmitted. Box 2 shows that the QR Code is sealed so that its integrity and ability to transmit data, will not be defeated by painting over it. Box 3 shows the artist then purchases or acquires the embedded canvas. Box 4 is step two which involves creating the original artwork. Box 5 is step three which involves the artist scanning his or her completed art work with a smart phone or other portable device. In is envisioned that the artist will waive his smart phone or other portable device over the canvas and the embedded QR Code. Box 6 is step four which involves sending the scanned image on the smart phone to the computer terminal belonging to a master controller for purposes of developing a registry of original artwork, which can be cataloged by date and time of receipt of the scanned image. And Box 7 shows step five which is optional, where the artist can contract to sell or Box 8 to license the original art, a digital representation of the original art is advertised or broadcast through the internet.

In another embodiment, the artist can access the master controller through a public website. Access to the website is available to all artists. In another embodiment, a device embedded in the canvas is a Non-Fungible token (“NFT”).

It is recognized that the description and the drawings are not intended to limit the present invention to a particular form as disclosed, rather the invention covers all modifications, equivalents, and alternatives which fall within the spirit and scope of the present invention.

I claim:

1. A computer driven system comprising:
a tangible, non-transitory, machine readable medium storing instruction that when executed, sends data related to an original artwork painted on a canvas containing an embedded quick response code, from at least one artist with a smart phone capable of scanning and sending a photographic representation of the original artwork,
to a master controller with at least one computer with a terminal, monitor screen and enabling software to receive the data related to the original artwork, and
where the master controller will then create a registry of all artwork received from at least one artist.

2. The system of claim 1, where the artist can access the master controller through a public website.

3. The system of claim 1, where a device embedded in the canvas is a nonfungible token containing a QR Code.

4. The system of claim 1, where the artist can sell the original artwork.

5. The system of claim 1, where the artist can license the original artwork and continue to track future sales or transfers of the original artwork, receiving a portion of each future sale or transfer.
